(19) United States
(12) Patent Application Publication
(10) Pub. No.: US 2007/0278878 A1
(43) Pub. Date: Dec. 6, 2007

(54) SLIDING-TYPE ELECTRONIC DEVICE WITH A SEMI-AUTOMATIC AND MAGNETIC OPENING MECHANISM

(76) Inventor: Kai-Cheng Yu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/751,591

(22) Filed: May 21, 2007

(30) Foreign Application Priority Data
Jun. 2, 2006 (TW) 095119653

(51) Int. Cl. H02K 7/06; H04M 1/00; H02K 7/10

(52) U.S. Cl. 310/81

(57) ABSTRACT

An electronic device includes a plurality link bars, a plurality of magnetic devices, a first module and a second module connected to the first module in a slideable manner. The magnetic devices are disposed at connecting nodes where the link bars are connected to each other. One connecting node of the link bars is fixed at the first module of the electronic device, and another connecting node of the link bars is fixed at the second module of the electronic device. The first and second modules are open and closed in a semi-automatic manner based on magnetic force formed between the magnetic devices disposed at the connecting nodes.

### BACKGROUND OF THE INVENTION

1. Field of the Invention

The present invention relates to an electronic device with a semi-automatic opening mechanism, and more particularly, to an electronic device with a semi-automatic and magnetic opening mechanism using link bars.

2. Description of the Prior Art

With rapid development of technologies, electronic devices are widely utilized in various fields. For instance, the utilization of a convenient and light mobile phone has become a common way of communication in daily lives. With these mobile devices, people can easily exchange or share information, experiences, and opinions. Mobile phones have progressed tremendously in recent years. Various types of mobile phones are continuously being developed and the demand is still increasing. Together with communication quality, appearance and size-reduction, the ability to provide a user with a more convenient operating environment is also a major concern when designing a mobile phone.

Some electronic devices adopt a sliding-type opening mechanism, such as sliding-type mobile phones. In contrast to vertical non-flip mobile phones, sliding-type mobile phones provide larger display panels, smaller sizes when closed, and do not require constant keyboard-locking. Reference is made to FIG. 1 for a diagram illustrating a prior art sliding-type mobile phone 10. The sliding-type mobile phone 10 includes a first module 12 and a second module 14. The second module 14 is connected to the topside of the first module 12 in a sliding manner so that a user can close or open the sliding-type mobile phone 10 by pushing the second module 14 towards or away from the first module 12. The first module 12 can include a display panel for displaying images having been processed by the sliding-type mobile phone 10. The second module 14 can include a processing unit for controlling operations of the sliding-type mobile phone 10 and a plurality of keypads for inputting control signals to the processing unit. The user can also make a phone call by dialing a telephone number using the keypads.

In the prior art sliding-type mobile phone 10, the movement of the first module 12 and the second module 14 is usually controlled by mechanical devices such as springs. The sliding-type mobile phone 10 can be semi-automatically opened and closed based on the inflection point of the springs. In FIG. 1, the first module 12 and the second module 14 of the sliding-type mobile phone 10 are connected using springs 15 and 17 each having two ends respectively connected to the first module 12 and the second module 14. The spring 15 can be curved in response to an external force. In order to close the sliding-type mobile phone 10, a user can apply an external force in a Direction 1 indicated by an arrow in FIG. 1. Once the spring 15 receives sufficient compression and its curvature reaches the inflection point, the inherent elasticity of the spring 15 continues to provide a force in the Direction 1 for closing the sliding-type mobile phone 10. Similarly, in order to open the sliding-type mobile phone 10, a user can apply an external force in a Direction 2 indicated by an arrow in FIG. 1. Once the spring 15 receives sufficient compression and its curvature reaches the inflection point, the inherent elasticity of the spring 15 continues to provide a force in the Direction 2 for opening the sliding-type mobile phone 10.

Reference is made to FIG. 2 for a diagram illustrating each stage of the spring 15 while opening/closing the sliding-type mobile phone 10. Stage 1 represents the spring 15 when the sliding-type mobile phone 10 is completely open, Stage 2 represents the spring 15 at its inflection point, and Stage 3 represents the spring 15 when the sliding-type mobile phone 10 is completely closed.

Reference is made to FIG. 3 for a diagram illustrating another prior art sliding-type mobile phone 30. The sliding-type mobile phone 30 also includes a first module 12 and a second module 14. The second module 14 is connected to the topside of the first module 12 in a sliding manner so that a user can close or open the sliding-type mobile phone 30 by pushing the second module 14 towards or away from the first module 12. The first module 12 and the second module 14 of the sliding-type mobile phone 30 are connected using a spring 35 having two ends respectively fixed to the first module 12 and the second module 14. The length of the spring 35 can change in response to an external force. In order to close the sliding-type mobile phone 30, a user can apply an external force in a Direction 1 indicated by an arrow in FIG. 3. Once the spring 35 receives sufficient compression and its length reaches the inflection point, the inherent elasticity of the spring 35 continues to provide a force in the Direction 1 for closing the sliding-type mobile phone 30. Similarly, in order to open the sliding-type mobile phone 30, a user can apply an external force in a Direction 2 indicated by an arrow in FIG. 3. Once the spring 35 receives sufficient compression and its length reaches the inflection point, the inherent elasticity of the spring 35 continues to provide a force in the Direction 2 for opening the sliding-type mobile phone 30.

Reference is made to FIG. 4 for a diagram illustrating each stage of the spring 35 while opening/closing the sliding-type mobile phone 30. Stage 1 represents the spring 35 when the sliding-type mobile phone 30 is completely open, Stage 2 represents the spring 35 at its inflection point, and Stage 3 represents the spring 35 when the sliding-type mobile phone 30 is completely closed.

In the prior art sliding-type mobile phones, mechanical devices such as springs are used for controlling the movement of the first module 12 and the second module 14. The prior art sliding-type mobile phones can be semi-automatically opened or closed using the inherent elasticity of the springs after reaching the inflection point. In such opening mechanism, the interior of the sliding-type mobile phones has to provide large space for disposing the springs, so that the springs can fully operates and provides sufficient stroke for opening and closing the sliding-type mobile phones. Therefore, in the prior art sliding-type mobile phones, large space is required for disposing the springs.

### SUMMARY OF THE INVENTION

The present invention provides an electronic device with a semi-automatic and magnetic opening mechanism comprising a first module; a second module disposed at a side of the first module in a slideable manner; a first link bar having a first end connected to the first module; a second link bar having a first end connected to the first module; a third link bar having a first end connected to the second module; a fourth link bar having a first end connected to the second module; a first magnetic device disposed at a second end of the first link bar and a second end of the third link bar; and a second magnetic device disposed at a second end of the second link bar and a second end of the fourth link bar, wherein the first and second magnetic devices have opposite polarities.

The present invention also provides an electronic device with a semi-automatic and magnetic opening mechanism comprising: a first module; a second module disposed at a side of the first module in a slideable manner; a first link bar having a first end connected to the first module; a second link bar having a first end connected to the first module; a third link bar having a first end connected to the second module; a fourth link bar having a first end connected to the second module; a first magnetic device disposed at the first end of the first link bar and the first end of the third link bar; and a second magnetic device disposed at the first end of the second link bar and the first end of the fourth link bar, wherein the first and second magnetic devices have opposite polarities.

The present invention also provides an electronic device with a semi-automatic and magnetic opening mechanism comprising: a first module; a second module disposed at a side of the first module in a slideable manner; a first link bar having a first end connected to the first module in a rotatable manner; a second link bar having a first end connected to the first module in a rotatable manner; a third link bar having a first end connected to the second module in a rotatable manner; a fourth link bar having a first end connected to the second module in a rotatable manner; a connecting device; a fifth link bar having a first end connected to the connecting device in a rotatable manner and a second disposed adjacent to a second end of the first link bar; a sixth link bar having a first end connected to the connecting device in a rotatable manner and a second disposed adjacent to a second end of the second link bar; a seventh link bar having a first end connected to the connecting device in a rotatable manner and a second disposed adjacent to a second end of the third link bar; a eighth link bar having a first end connected to the connecting device in a rotatable manner and a second disposed adjacent to a second end of the fourth link bar; a first magnetic device disposed at the second end of the first link bar and the second end of the fifth link bar; and a second magnetic device disposed at the second end of the second link bar and the second end of the sixth link bar, wherein the first and second magnetic devices have opposite polarities.

The present invention also provides an electronic device with a semi-automatic and magnetic opening mechanism comprising: a first module; a second module disposed at a side of the first module in a slideable manner; a first link bar having a first end connected to the first module in a rotatable manner; a second link bar having a first end connected to the first module in a rotatable manner; a third link bar having a first end connected to the second module in a rotatable manner; a fourth link bar having a first end connected to the second module in a rotatable manner; a connecting device; a fifth link bar having a first end connected to the connecting device in a rotatable manner and a second disposed adjacent to a second end of the first link bar; a sixth link bar having a first end connected to the connecting device in a rotatable manner and a second disposed adjacent to a second end of the second link bar; a seventh link bar having a first end connected to the connecting device in a rotatable manner and a second disposed adjacent to a second end of the third link bar; a eighth link bar having a first end connected to the connecting device in a rotatable manner and a second disposed adjacent to a second end of the fourth link bar; a first magnetic device disposed at the first end of the first link bar and the first end of the second link bar; and a second magnetic device disposed at the first end of the third link bar and the first end of the fourth link bar.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art sliding-type mobile phone.

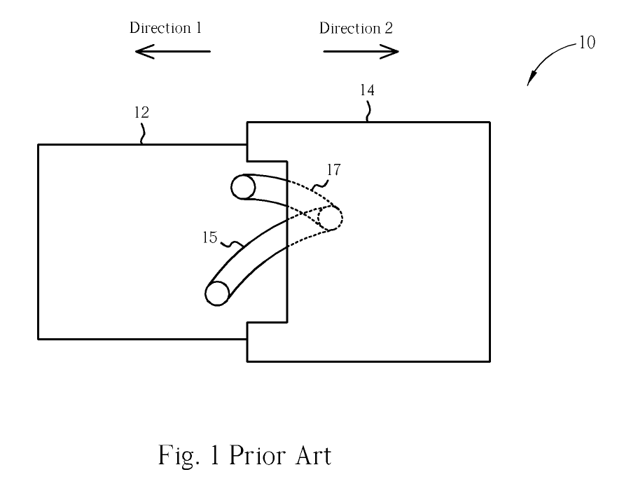

FIG. 2 is a diagram illustrating each stage of a spring in the sliding-type mobile phone of FIG. 1.

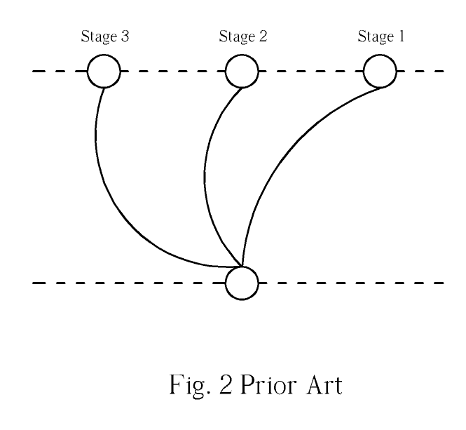

FIG. 3 is a diagram illustrating another prior art sliding-type mobile phone.

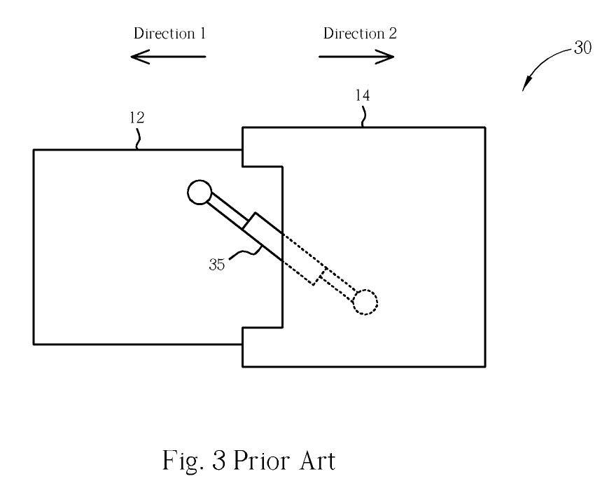

FIG. 4 is a diagram illustrating each stage of a spring in the sliding-type mobile phone of FIG. 3.

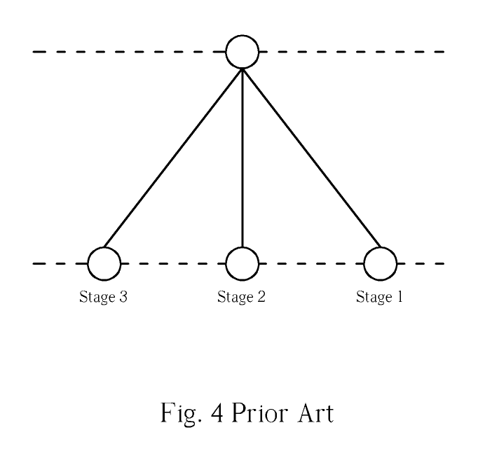

FIG. 5 is an explosive diagram of a connecting device according to a first embodiment of the present invention.

FIG. 6 is a diagram illustrating a method for assembling each device of the connecting device in FIG. 5.

FIG. 7 is a top-view diagram of the connecting device in FIG. 5 after all the devices are assembled.

FIG. 8 is a table listing polarity combinations of the magnetic devices.

FIG. 9 is a diagram illustrating a sliding-type mobile phone according to the present invention.

FIG. 10 is a diagram illustrating a sliding-type mobile phone according to the present invention.

FIG. 11 is a diagram of a connecting device according to a second embodiment of the present invention.

FIG. 12 is a diagram of a connecting device according to a third embodiment of the present invention.

FIG. 13 is a table listing possible polarities present at the corners M1-M3.

FIG. 14 is a table listing possible polarities present at the corners L1, L2, R1 and R2.

### DETAILED DESCRIPTION

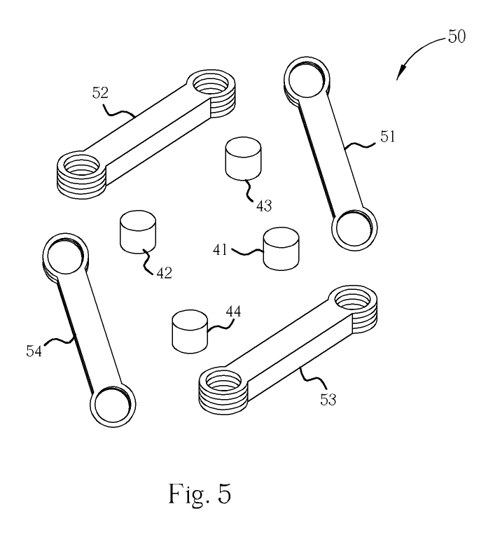

Reference is made to FIG. 5 for an explosive diagram of a connecting device 50 according to a first embodiment of the present invention. The connecting device 50 can be used in electronic devices having a slidable housing, such as a sliding-type mobile phone. The connecting device 50 includes four link bars 51-54 and four magnetic devices 41-44. The two ends of the link bars 51-54 each include a hole, within which the magnetic devices 41-44 can be disposed.

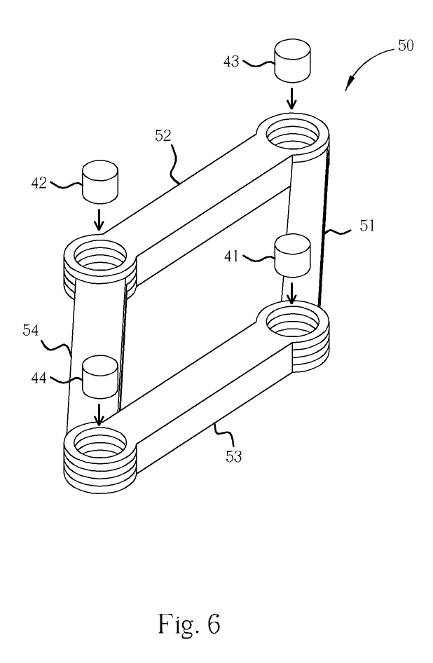

Reference is made to FIG. 6 for a diagram illustrating a method for assembling each device of the connecting device 50. First, the holes at the two ends of the link bars 51-54 are aligned in a manner as illustrated in FIG. 6. The magnetic devices 41-44 can then be disposed inside the aligned holes for connecting the link bars 51-54. In the first embodiment of the present invention, the magnetic devices 41-44 are circular for fitting in with the holes at the two ends of the link bars 51-54. In other words, the link bars 51-54 are connected in a rotatable manner using the magnetic devices 41-44. The angles between two adjacent link bars are also changeable.

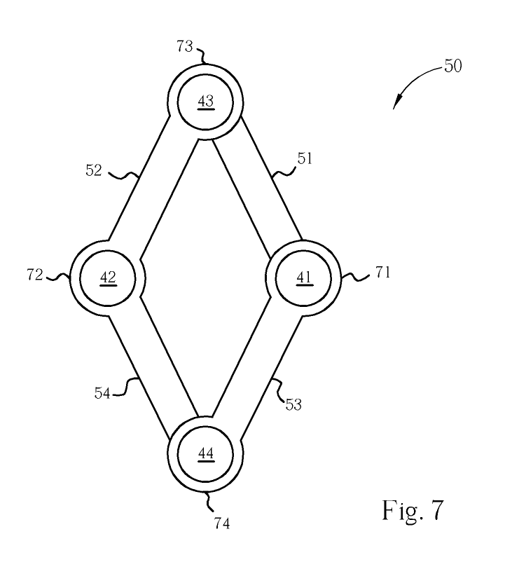

Reference is made to FIG. 7 for a top-view diagram of the connecting device 50 after all the devices are assembled. The assembled connecting device 50 resembles a parallelogram having four corners 71-74. The magnetic device 41 and the link bars 51 and 53 are connected at the corner 71, the magnetic device 42 and the link bars 52 and 54 are connected at the corner 72, the magnetic device 43 and the link bars 51 and 52 are connected at the corner 73, and the magnetic device 44 and the link bars 53 and 54 are connected at the corner 74.

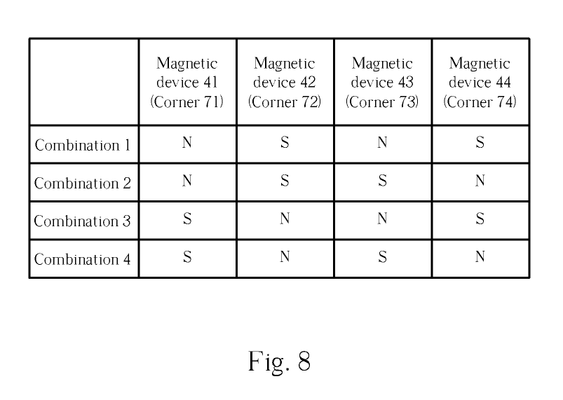

In the first embodiment of the present invention, the magnetic devices 41-44 can include magnets whose possible polarity combinations are depicted in FIG. 8. In FIG. 8, “N” and “S” represent the N polarity and the S polarity, respectively. As shown in Combinations 1-4, the magnetic device 41 disposed at the corner 71 and the magnetic device 42 disposed at the corner 72 have opposite polarities, while the magnetic device 43 disposed at the corner 73 and the magnetic device 44 disposed at the corner 74 have opposite polarities.

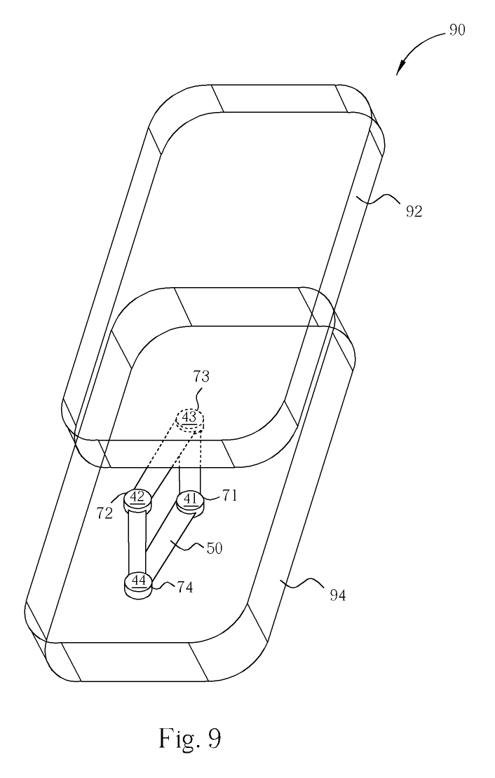

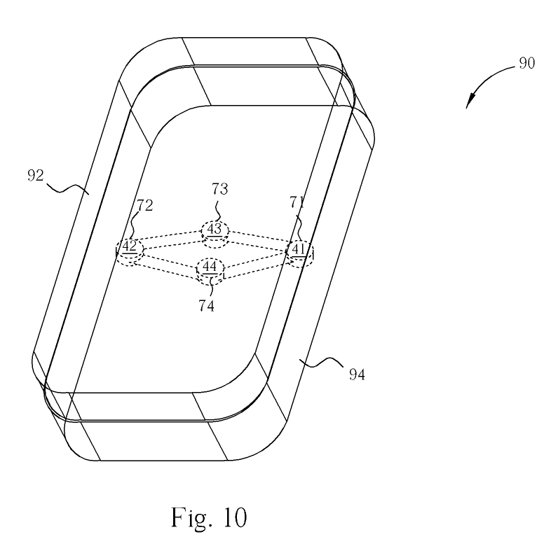

Reference is made to FIGS. 9 and 10 for diagrams illustrating a sliding-type mobile phone 90 according to the present invention. FIG. 9 shows the sliding-type mobile phone 90 when it is open, and FIG. 10 shows the sliding-type mobile phone 90 when it is closed. The sliding-type mobile phone 90 includes a first module 92, a second module 94, and the connecting device 50. The corners 73 and 74 of the connecting device 50 are respectively fixed to the first module 92 and the second module 94. When a user is opening the sliding-type mobile phone 90, the applied force increases the distance between the corners 73 and 74 of the connecting device 50 and shortens the distance between the corners 71 and 72 of the connecting device 50. Since the magnetic devices 41 and 42 have opposite polarities, when the distance between the corners 71 and 72 becomes smaller than the magnetic range of the magnetic devices 41 and 42, the magnetic force between the magnetic devices 41 and 42 begin to function. At this moment, the user no longer needs to apply any force. Instead, the magnetic force between the magnetic devices 41 and 42 automatically draws the corners 71 and 72 towards each other and further shortens the distance between the corners 71 and 72. Meanwhile, the distance between the corners 73 and 74 is increased further, separating the first module 92 fixed to the corner 73 from the second module 94 fixed to the corner 74, thereby opening the sliding-type mobile phone 90, as shown in FIG. 9. Similarly, when a user is closing the sliding-type mobile phone 90, the applied force increases the distance between the corners 71 and 72 of the connecting device 50 and shortens the distance between the corners 73 and 74 of the connecting device 50. Since the magnetic devices 43 and 44 have opposite polarities, when the distance between the corners 73 and 74 becomes smaller than the magnetic range of the magnetic devices 43 and 44, the magnetic force between the magnetic devices 43 and 44 begin to function. At this moment, the user no longer needs to apply any force. Instead, the magnetic force between the magnetic devices 43 and 44 draws the corners 73 and 74 towards each other and further shortens the distance between the corners 73 and 74. Therefore, the first module 92 fixed to the corner 73 and the second module 94 fixed to the corner 74 are drawn towards each other until the sliding-type mobile phone 90 is completely closed, as shown in FIG. 10.

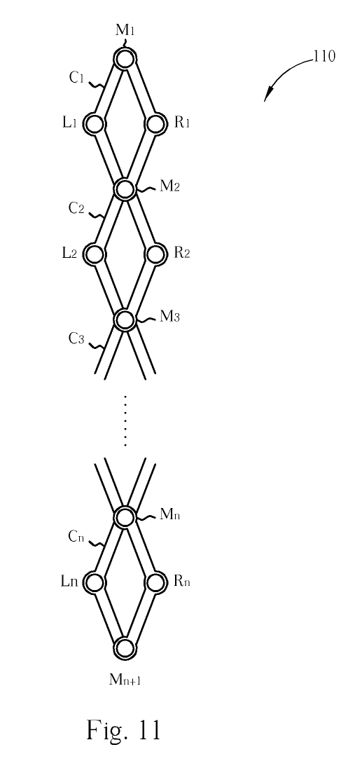

Reference is made to FIG. 11 for a diagram of a connecting device 110 according to a second embodiment of the present invention. The connecting device 110 includes a plurality of connecting devices C₁-Cₙ, each of which can adopt the connecting device 50. Corners M₁-Mₙ₊₁ can move in the direction parallel to the moving direction of the first and second modules, while corners L₁-Lₙ and R₁-Rₙ can move in the direction perpendicular to the moving direction of the first and second modules, as shown in FIG. 11. As the size of a sliding-type mobile phone decreases, a connecting device used to connect the first and second modules of the sliding-type mobile phone has to be small, so that the sliding-type mobile phone can provide more space for other devices. When a large display panel is used in the sliding-type mobile phone, the small connecting device 50 may not be able to provide sufficient stroke in the moving direction of the first and second modules. Since the connecting device 110 includes a plurality of connecting devices C₁-Cₙ, it can provide a larger stroke in the moving direction of the first and second modules. Magnetic devices can be disposed at the corners M₁ and Mₙ₊₁ of the connecting device 110, as well as at corresponding corners of a connecting device among the connecting devices C₁-Cₙ (such as at the corners L₁ and R₁ of the connecting device C₁). Magnetic or non-magnetic devices can be disposed on other corners of the connecting device 110. The polarities of the magnetic devices depend on the number of the connecting devices C₁-Cₙ and have to satisfy the following conditions:

Condition 1: Among the corners M₁-Mₙ₊₁, the magnetic devices disposed at two adjacent corners must not repulse each other, or must provide a magnetic force for drawing the corner M₁ and Mₙ₊₁ towards each other when the distance between corners M₁ and Mₙ₊₁ becomes smaller than a predetermined value.

Condition 2: Among the corners L₁-Lₙ, the magnetic devices disposed at two adjacent corners must not repulse each other, or must provide a magnetic force for drawing the corner L₁ and Lₙ towards each other when the distance between corners L₁ and Lₙ becomes smaller than a predetermined value.

Condition 3: Among the corners R₁-Rₙ, the magnetic devices disposed at two adjacent corners must not repulse each other, or must provide a magnetic force for drawing the corner R₁ and Rₙ towards each other when the distance between corners R₁ and Rₙ becomes smaller than a predetermined value.

Condition 4: The magnetic devices respectively disposed at the corners R₁ and L₁, R₂ and L₂, . . . , and Rₙ and Lₙ must not repulse each other, or must provide a magnetic force for drawing the corners R₁ and L₁, R₂ and L₂, . . . , and Rₙ and Lₙ towards each other when the distances between the corners R₁ and L₁, R₂ and L₂, . . . , and Rₙ and Lₙ each become smaller than a predetermined value.

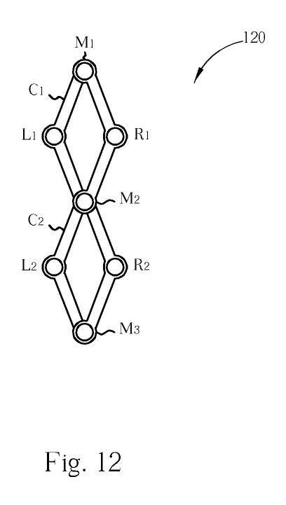

Reference is made to FIG. 12 for a diagram of a connecting device 120 according to a third embodiment of the present invention. The connecting device 120, based on the structure of the connecting device 110, includes connecting devices C₁ and C₂, each of which can adopt the connecting device 50. Corners M₁, M₂, M₃, L₁, L₂, R₁ and R₂ represent the connecting points of the link bars. The corners M₁ and M₃ can be fixed to a first module and a second module of a sliding-type mobile phone, respectively.

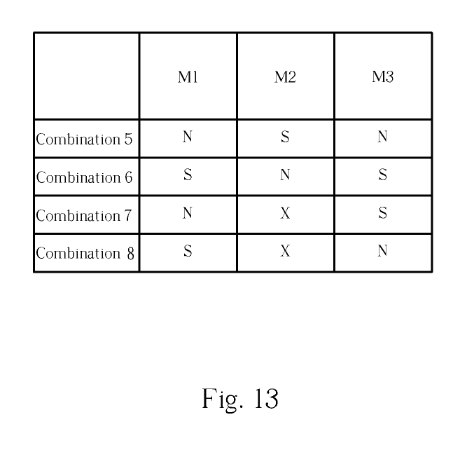

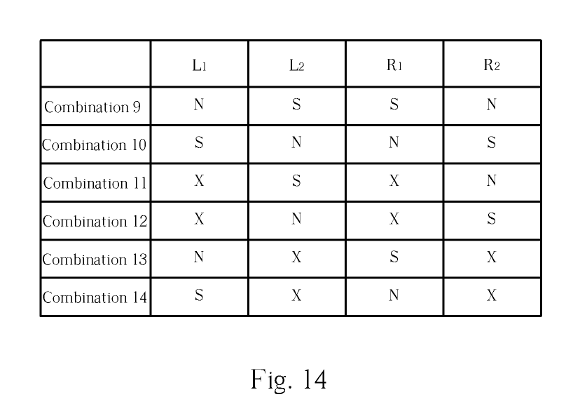

As long as the Conditions 1-4 are satisfied, magnetic or non-magnetic devices can be disposed on the corners M₁, M₂, M₃, L₁, L₂, R₁ and R₂. FIG. 13 shows a table listing possible polarities present at the corners M₁-M₃, and FIG. 14 shows a table listing possible polarities present at the corners L₁, L₂, R₁ and R₂. In FIGS. 13 and 14, “N” and “S” represent the N polarity and the S polarity, respectively. In FIG. 13, when a magnetic device is disposed at the corner M₂, the magnetic devices disposed at the corners M₁ and M₃ have the same polarity, as shown by Combination 5 and Combination 6 in FIG. 13. When a non-magnetic device (represented by an “X” in FIG. 13) is disposed at the corner M₂, the magnetic devices disposed at the corners M₁ and M₃ have opposite polarities, as shown by Combination 7 and Combination 8 in FIG. 13. In FIG. 14, when magnetic devices are disposed at the corner L₁, L₂, R₁ and R₂, the magnetic devices disposed at the corners L₁ and R₁, at the corners L₂ and R₂, at the corners L₁ and L₂, and at the corners R₁ and R₂ all have opposite polarities, as shown by Combination 9 and Combination 10 in FIG. 14. When non-magnetic devices (represented by a “X” in FIG. 14) are disposed at the corner L₁, L₂, R₁ and R₂, the magnetic devices disposed at the corners L₁ and L₂ or at the corners L₂ and R₂ have opposite polarities, as Combinations 11-14 shown in FIG. 14.

According to Combinations 5-8 in FIG. 13 and Combinations 9-14 in FIG. 14, the connecting device can have 24 structures. The devices disposed at the corners M₁-M₃ provide a magnetic force for drawing the first and second modules closer to each other and thereby closing the sliding-type mobile phone semi-automatically. The semi-automatic closing force is generated between the two adjacent corners among the corners M₁-M₃ in Combinations 5 and 6, and between the corners M₁ and M₃ in Combinations 7 and 8. Compared to Combinations 7 and 8, Combinations 5 and 6 can provide a larger semi-automatic closing force. Also in Combinations 9 and 10, magnetic devices having opposite polarities are disposed at the corners L₁, L₂ and corners R₁, R₂ for further providing another semi-automatic closing force.

In the first through third embodiments of the present invention, the two ends of the link bars each include a circular hole, and circular magnetic or non-magnetic devices can be disposed within the holes, as illustrated in FIG. 6. As a result, two adjacent link bars can be connected to each other in a rotatable manner using the magnetic or non-magnetic devices, and the sliding-type mobile phone can be opened or closed by changing the angle between two adjacent link bars. However, the present invention is not limited to the assembling method illustrated in FIG. 6, nor to link bars with circular holes at the two ends, and nor to circular magnetic devices. For example, the link bars used in the present invention can be connected in another way before disposing magnetic or non-magnetic devices. Or, magnetic or non-magnetic devices can be formed together with the link bars before connecting the link bars. In addition, the present invention can be used in sliding-type mobile phones, as well as other electronic devices having a moving housing, such as a personal digital assistant (PDA).

In the prior art sliding-type mobile phone, a semi-automatic opening mechanism is achieved based on the inflection point of a spring. Therefore, in the prior art sliding-type mobile phone, large space is required for disposing the spring, so that the spring can fully operate and provide sufficient stroke for opening and closing the sliding-type mobile phone. In the present invention, a semi-automatic opening mechanism is provided for a sliding-type mobile phone using a connecting device including link bars and magnetic devices. When a user opens or closes the sliding-type mobile phone to a certain degree, the magnetic forces present at the corners of the link bars continue to open or close the sliding-type mobile phone automatically. Therefore, the present invention can provide a small and convenient sliding-type mobile phone.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device with a semi-automatic and magnetic opening mechanism comprising:
a first module;
a second module disposed at a side of the first module in a slideable manner;
a first link bar having a first end connected to the first module;
a second link bar having a first end connected to the first module;
a third link bar having a first end connected to the second module;
a fourth link bar having a first end connected to the second module;
a first magnetic device disposed at a second end of the first link bar and a second end of the third link bar; and
a second magnetic device disposed at a second end of the second link bar and a second end of the fourth link bar, wherein the first and second magnetic devices have opposite polarities.

2. The electronic device of claim 1 wherein the first and magnetic devices include magnets.

3. The electronic device of claim 1 wherein the first magnetic device is disposed within a hole at the second end of the first link bar and a hole at the second end of the third link bar, while the second magnetic device is disposed within a hole at the second end of the second link bar and a hole at the second end of the fourth link bar.

4. The electronic device of claim 1 further comprising:
a third magnetic device disposed at the first end of the first link bar and the first end of the second link bar; and
a fourth magnetic device disposed at the first end of the third link bar and the first end of the fourth link bar, wherein the third and fourth magnetic devices have opposite polarities.

5. The electronic device of claim 4 wherein the third and fourth magnetic devices include magnets.

6. The electronic device of claim 4 wherein the third magnetic device is disposed within a hole at the first end of the first link bar and a hole at the first end of the second link bar, while the second magnetic device is disposed within a hole at the first end of the third link bar and a hole at the first end of the fourth link bar.

7. The electronic device of claim 1 wherein the second end of each link bar is disposed within a space between the first and second modules in a movable manner.

8. The electronic device of claim 1 wherein the first module includes a display panel for displaying images.

9. The electronic device of claim 1 wherein the second module includes:
a processing unit for controlling operations of the electronic device; and
a plurality of keypads for inputting control signals to the processing unit.

10. The electronic device of claim 1 being a mobile phone.

11. An electronic device with a semi-automatic and magnetic opening mechanism comprising:
a first module;
a second module disposed at a side of the first module in a slideable manner;
a first link bar having a first end connected to the first module;
a second link bar having a first end connected to the first module;
a third link bar having a first end connected to the second module;
a fourth link bar having a first end connected to the second module;
a first magnetic device disposed at the first end of the first link bar and the first end of the third link bar; and
a second magnetic device disposed at the first end of the second link bar and the first end of the fourth link bar, wherein the first and second magnetic devices have opposite polarities.

12. The electronic device of claim 11 wherein the first magnetic device is disposed within a hole at the first end of the first link bar and a hole at the first end of the third link bar, while the second magnetic device is disposed within a hole at the first end of the second link bar and a hole at the first end of the fourth link bar.

13. The electronic device of claim 11 further comprising:
a third magnetic device disposed at a second end of the first link bar and a second end of the third link bar; and
a fourth magnetic device disposed at a second end of the second link bar and a second end of the fourth link bar, wherein the third and fourth magnetic devices have opposite polarities.

14. The electronic device of claim 13 wherein the third magnetic device is disposed within a hole at the second end of the first link bar and a hole at the second end of the third link bar, while the second magnetic device is disposed within a hole at the second end of the second link bar and a hole at the second end of the fourth link bar.

15. The electronic device of claim 11 wherein the second end of each link bar is disposed within a space between the first and second modules in a movable manner.

16. An electronic device with a semi-automatic and magnetic opening mechanism comprising:
a first module;
a second module disposed at a side of the first module in a slideable manner;
a first link bar having a first end connected to the first module in a rotatable manner;
a second link bar having a first end connected to the first module in a rotatable manner;
a third link bar having a first end connected to the second module in a rotatable manner;
a fourth link bar having a first end connected to the second module in a rotatable manner;
a connecting device;
a fifth link bar having a first end connected to the connecting device in a rotatable manner and a second disposed adjacent to a second end of the first link bar;
a sixth link bar having a first end connected to the connecting device in a rotatable manner and a second disposed adjacent to a second end of the second link bar;
a seventh link bar having a first end connected to the connecting device in a rotatable manner and a second disposed adjacent to a second end of the third link bar;
a eighth link bar having a first end connected to the connecting device in a rotatable manner and a second disposed adjacent to a second end of the fourth link bar;
a first magnetic device disposed at the second end of the first link bar and the second end of the fifth link bar; and
a second magnetic device disposed at the second end of the second link bar and the second end of the sixth link bar, wherein the first and second magnetic devices have opposite polarities.

17. The electronic device of claim 16 wherein the connecting device includes a magnetic device.

18. The electronic device of claim 16 wherein the connecting device includes a plurality of link bars connected to each other.

19. The electronic device of claim 16 further comprising:
a third magnetic device disposed at the second end of the third link bar and the second end of the seventh link bar; and
a fourth magnetic device disposed at the second end of the second link bar and the second end of the eighth link bar, wherein the third and fourth magnetic devices have opposite polarities.

20. The electronic device of claim 19 wherein the connecting device includes a non-magnetic device, and the first and second magnetic devices have opposite polarities.
